(19) United States
(12) Patent Application Publication
(10) Pub. No.: US 2014/0140378 A1
(43) Pub. Date: May 22, 2014

(54) RAKE RECEIVER WITH NOISE WHITENING

(71) Applicants: Rajarajan Balraj, Duesseldorf (DE); Herbert Dawid, Herzogenrath (DE); Thorsten Clevorn, Duesseldorf (DE); Edgar Bolinth, Korschenbroich (DE); Markus Jordan, Aachen (DE)

(72) Inventors: Rajarajan Balraj, Duesseldorf (DE); Herbert Dawid, Herzogenrath (DE); Thorsten Clevorn, Duesseldorf (DE); Edgar Bolinth, Korschenbroich (DE); Markus Jordan, Aachen (DE)

(21) Appl. No.: 13/680,107

(22) Filed: Nov. 18, 2012

(51) Int. Cl. H04B 1/7115

(52) U.S. Cl. CPC H04B 1/7115
USPC 375/148

(57) ABSTRACT

Described devices and techniques provide noise whitening in a communication device. The noise whitening is performed by a noise whitening unit that receives signals on a first path associated with a first antenna and signals on a second path associated with a second antenna. The received signals may include radio signals and channel coefficient signals. The noise whitening unit may perform noise whitening of the received signals in consideration of a covariance of the interference and noise associated with the received radio signals.

### BACKGROUND

Wireless communication systems are well known and in widespread use. Cellular communication networks typically include a plurality of base stations geographically located to serve corresponding regions or cells. Mobile stations such as cell phones, personal digital assistants and laptop computers communicate using radio frequency signals through the base stations to a cellular network, which facilitates communications with other devices.

Wireless communication devices or units, such as the referred to mobile stations, provide data and voice services for users operating in corresponding systems, such as the referred to wireless communication systems. As these systems have evolved more sophisticated encoding and modulation schemes are being employed. Present systems often rely at least in part on schemes where orthogonality between signals is utilized to distinguish a signal from all others. A classic example of such a system is a spread spectrum system, such as a Code Division Multiple Access (CDMA) system where spreading codes that are orthogonal to each other are used to distinguish one signal from another.

In wireless communications, such communications generated by systems that employ spread spectrum techniques, a transmitted signal (e.g. radio signals) may be received at a wireless receiver via multiple transmission paths. In other words, the wireless receiver includes an antenna that may receive the same transmitted signal via multiple paths.

Such multipath communication may cause reception errors and decrease quality in wireless communications. For example, multipath communication may cause intersymbol interference (ISI), also referred to here as simply interference. A signal received via one of the paths may be out of phase with the same signal received via another one of the paths. Signals that are received in phase with each other result in a stronger signal at the wireless receiver. Conversely, out of phase signals result in a weak or fading signal at the wireless receiver (i.e. result in multipath fading). Furthermore, noise may negatively influence multipath communication and reception of such multipath communication.

A wireless receiver may include a rake receiver to compensate for the effects of multipath fading. For example, the wireless receiver may include a radio frequency module that receives wireless signals from an antenna or a plurality of antenna. The rake receiver decodes each individual path independently and combines the strongest transmission characteristics of each of the paths to generate an output signal.

A conventional rake receiver includes a plurality of fingers and a plurality of corresponding delay modules. The fingers receive multipath signals via a corresponding transmission path. Each of the fingers despreads a corresponding one of the multipath signals. The delay modules adjust time offsets of the multipath signals. A combining module combines the adjusted multipath signals and generates an output signal. The combined output signal may have a higher signal-to-noise ratio than any of the individual multipath signals.

The mitigation of interference and noise is important in wireless systems. Therefore, improved and diverse methods to mitigate such interference and noise found in receiver designs may be advantageous.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an exemplary receiver that implements noise whitening. The receiver may include a noise whitening unit as a frontend to a rake receiver.

FIG. 2 illustrates an exemplary implementation of the noise whitening unit illustrated in FIG. 1, and the signals received that may be received by the noise whitening unit.

FIG. 3 illustrates a representative noise whitening process for enabling interference and noise mitigation. The noise whitening process may be implemented in a receiver, such as a rake receiver.

FIG. 4 illustrates a representative wireless device that may incorporate the exemplary receiver that implements noise whitening.

### DETAILED DESCRIPTION

### Overview

Representative implementations of devices and techniques provide noising whitening of received signals to mitigate interference and/or noise associated with the received signals. In one implementation, the noise whitening of received signals is incorporated into a rake receiver, such as one found in a diversity receiver that uses a plurality of antennas. In a particular implementation, the noise whitening is performed by a noise whitening unit that receives signals on a first path associated with a first antenna and signals on a second path associated with a second antenna. The received signals may include radio signals and channel coefficient signals, such channel coefficient signals may characterize one or more signal path states and may include coefficients of channel impulse response. The noise whitening unit may perform noise whitening of the received signals in consideration of a covariance of the interference and noise associated with the received radio signals.

Various implementations, including techniques and devices, are discussed with reference to the figures. The techniques and devices discussed may be applied to any of various communication designs, circuits, and devices and remain within the scope of the disclosure.

Implementations are explained in more detail below using a plurality of examples. Although various implementations and examples are discussed here and below, further implementations and examples may be possible by combining the features and elements of individual implementations and examples.

### Exemplary Receiver

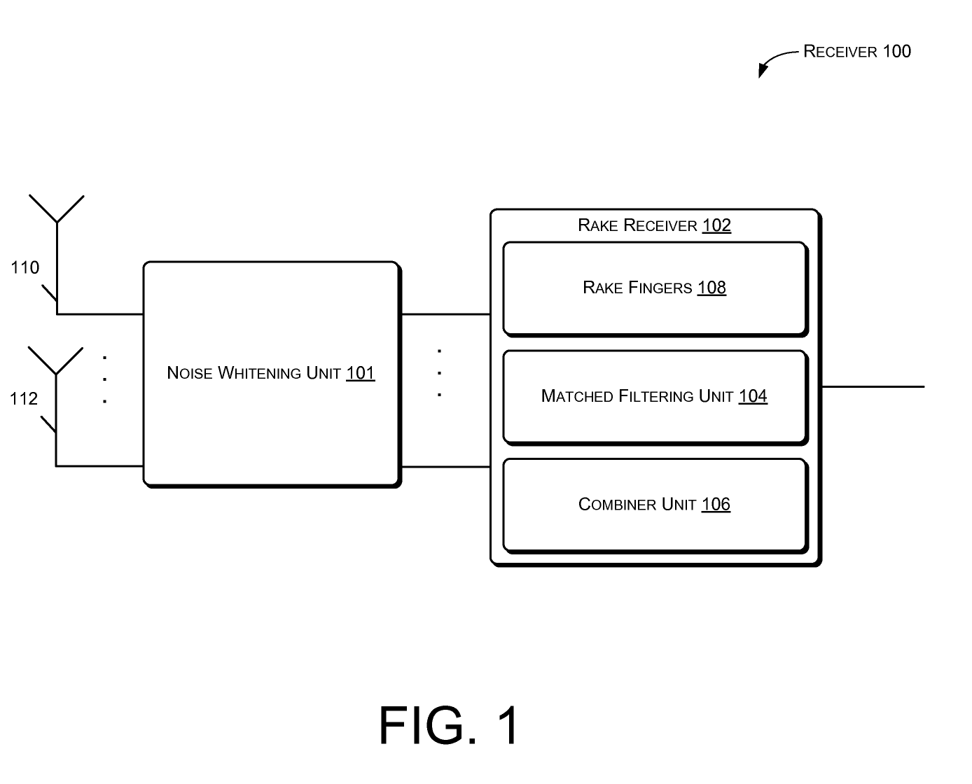

FIG. 1 illustrates an exemplary receiver 100 that implements noise whitening. The majority of the radio frequency components are not shown in order to simplify the drawing, and only a number of the baseband related functional blocks are shown. In this framework, a noise whitening unit 101 is followed by a rake receiver 102. The rake receiver 102 is illustrated as including a plurality of rake fingers 108, a matched filtering unit 104 and a combiner unit 106. The rake fingers 108, matched filtering unit 104 and combiner unit 106 are conventional. However, nonetheless, a general description of those units is provided in the following. The exemplary receiver also includes a plurality of antennas 110 and 112. Additional antennas may also be used. Although the noise whitening unit 101 is illustrated as being coupled to a rake receiver 102, it is to be understood that such is a non-limiting example. For example, the noise whitening unit 101 may be used in receiver designs that do not employ the use of a rake receiver. In a general sense, the noise whitening unit 101 may be a frontend unit that precedes a generic receiver, either externally or internally to the generic receiver.

Radio frequency signals received by the plurality of antennas 110 and 112 may be transmitted by a base station or a plurality of base stations (not shown). The radio frequency signals are transmitted over an air interface and propagate from one or more antennas of the base station to the multiple receive antennas 110 to 112 via different transmission channels (e.g. first channel and second channel in case of two receive antennas). It is to be noted that the communications system need not be restricted to only two transmission channels and two receive antennas, but may be based on an arbitrary number of transmission channels. Moreover, the arbitrary number of transmission channels may be provided by a number of antennas being greater than two.

Interference and noise occurring between the different transmission channels of multipath signals may lead to a degraded link quality. The radio signals transmitted over the first channel are received at the antenna 110 and processed in the rake receiver 102. In a similar way, the radio signals transmitted over the second transmission channel are received at the antenna 112 and processed in the rake receiver 102.

In further detail, the radio signals transmitted over the first channel may comprise a plurality of signal paths (e.g., multipath signals). The foregoing is true for the second channel. Each of the individual signal paths is received by an individual one of the rake fingers 108. In the example shown in FIG. 1, the rake fingers 108 may be paired as rake finger sets, where a first rake finger in the set receives whitened signals, processed by the noise whitening unit 101, on a signal path associated with antenna 110 and a second rake finger in the set receives signals, also processed by the noise whitening unit 101, on a signal path associated with the antenna 112. The signals on the signal paths may be comprised of one or more whitened radio frequency signals and one or more whitened channel coefficients, where the whitened signals have been processed by the noise whitening unit 101 to mitigate interference and/or noise.

The rake fingers 108 process received signals in a conventional manner and output respective rake processed signals to the matched filtering unit 104 that is matched to the pulse shape of a desired signal in the output signal(s) of the noise whitening unit 101. The matched filtering unit 104 outputs filtered signals that are received by the combiner unit 106. There may be a plurality of matched filtering units, where each matched filtering unit 104 is coupled to a set of rake fingers 108. The combiner unit 106 coherently combines the signals from the matched filtering unit 104 with a specific algorithm, such as maximum ratio combining algorithm, to provide a sampled output signal.

The receiver 100, and other devices and methods described herein, may be used in association with various wireless communication networks such as Code Division Multiple Access (CDMA), Time Division Multiple Access (TDMA), Frequency Division Multiple Access (FDMA), Orthogonal FDMA (OFDMA) and Single Carrier FDMA (SC-FDMA) networks. A CDMA network may implement a radio technology such as Universal Terrestrial Radio Access (UTRA), cdma2000, etc. UTRA includes Wideband-CDMA (WCDMA) and other CDMA variants. cdma2000 covers IS-2000, IS-95, and IS-856 standards. A TDMA network may implement a radio technology such as Global System for Mobile Communications (GSM) and derivatives thereof such as e.g. Enhanced Data Rate for GSM Evolution (EDGE), Enhanced General Packet Radio Service (EGPRS), etc. An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS).

In radio communications systems, a transmitter transmitting one or more radio communications signals on one or more radio communications channels may be present. In particular, the transmitter may be a base station or a transmitting device included in a user's device, such as a mobile radio transceiver, a handheld radio device or any similar device. Radio communications signals transmitted by transmitters may be received by receivers such as a receiving device in a mobile radio transceiver, a handheld radio device or any similar device. In particular, radio communications systems as disclosed herein may include UMTS systems which may conform to the 3GPP standard for UMTS systems. Radio communications signals as disclosed herein may be provided in UMTS systems, in particular over radio communications physical channels, such as primary common pilot channels, secondary common pilot channels, dedicated physical channels, dedicated physical control channels or similar channels according to the UMTS standard.

The various units, elements, devices and such may be implemented as computer (e.g., one or more processors) readable and executable instructions (e.g., software) stored at least partially or entirely on one or more tangible medium (e.g., memory and disk), hardware (e.g., logic and other electrical circuitry), or a combination of computer executable instructions stored at least partially or entirely on one or more tangible medium and hardware.

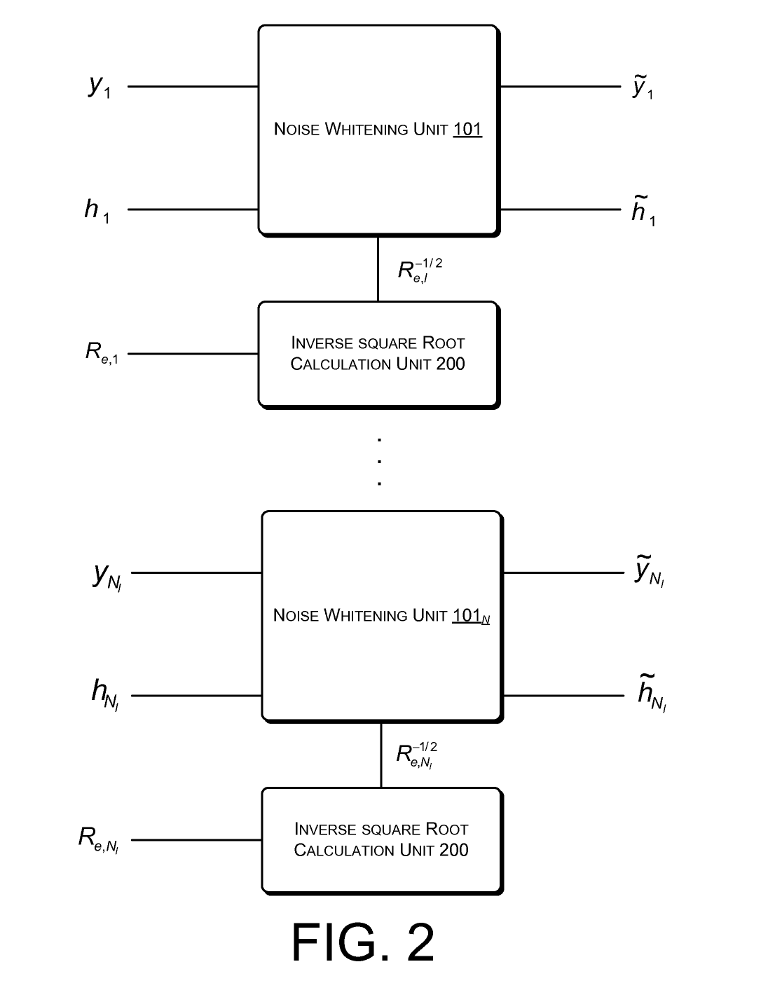

FIG. 2 illustrates an exemplary implementation of the noise whitening unit 101 and the signals received thereby. There may be multiple noise whitening units 101_{N}, where the number of noise whitening units 101_{N} corresponds to a number of receive antennas Nᵣₓ. In one example, the number of noise whitening units 101_{N} corresponds to a number of receive paths and a number of fingers of a rake receiver associated with the noise whitening units 101_{N}. The noise whitening unit 101 receives signals y₁ and h₁, in one implementation after undergoing despreading, where generally the following holds true as shown in (1):

$$\{ \begin{matrix}{y}_{l} = {h}_{l} x + {e}_{l} \\ where , \\ {N}_{rx} is the numberof receive antennas \\ \begin{matrix}{h}_{l} is the channel coefficients of the path l \\ of dimensioned matrix {N}_{rx} \times 1\end{matrix} \\ \begin{matrix}{e}_{l} is the interference and noisevector of the path l \\ of dimensioned matrix {N}_{rx} \times 1\end{matrix}\end{matrix} \} \qquad ( 1 )$$

The noise whitening unit 101 is coupled to an inverse square root calculation unit 200. The inverse square root unit 200 may be coupled to each of the noise whitening units 101_{N}, or there may be multiple inverse square root units, where an individual inverse square root unit is coupled to an individual noise whitening unit. The inverse square root calculation unit 200 receives a covariance matrix, which may be structured, of the noise and interference vector eₗ associated with the signals received by the noise whitening unit 101, for a given signal path. This structured covariance matrix is denoted as R_{e,l}. Known methods may be used to obtain an estimate of the covariance matrix R_{e,l}.

The inverse square root calculation unit 200 performs an inverse square root operation on the covariance matrix R_{e,l} to provide R_{e,l}^{-1/2}, which is the inverse square root of the covariance matrix R_{e,l}. The inverse square root R_{e,l}^{-1/2} of the covariance matrix is provided to the noise whitening unit 101. The noise whitening unit 101, for each path l, provides a whitened transformation of each of the received signals yₗ and hₗ, where the whitened transformations are given by (2):

$$\{ \begin{matrix}{\tilde{y}}_{l} = {R}_{e , l}^{- 1 / 2} {y}_{l} \\ {\tilde{h}}_{l} = {R}_{e , l}^{- 1 / 2} {h}_{l}\end{matrix} \} \qquad ( 2 )$$

The inverse square root calculation unit 200 may perform the inverse square root operation using a variety of techniques. One technique is Eigen value decomposition, as is given in (3):

$$\{ \begin{matrix}{R}_{e , l}^{- 1 / 2} = {US}^{- 1 / 2} {U}^{H} \\ where \\ U = [ {v}_{1} , … {v}_{{N}_{rx}} ] is the matrix {includingN}_{rx} Eigen vectors of {R}_{e , l} \\ S = ( \begin{matrix}{λ}_{1} & 0 & 0 & 0 \\ 0 & ⋱ & 0 & 0 \\ 0 & 0 & ⋱ & 0 \\ 0 & 0 & 0 & {λ}_{{N}_{rx}}\end{matrix} ) is a diagonalmatrixincludingEigen values of {R}_{e , l} \\ {S}^{- 1 / 2} = ( \begin{matrix}{λ}_{1}^{- 1 / 2} & 0 & 0 & 0 \\ 0 & ⋱ & 0 & 0 \\ 0 & 0 & ⋱ & 0 \\ 0 & 0 & 0 & {λ}_{{N}_{rx}}^{- 1 / 2}\end{matrix} )\end{matrix} \} \qquad ( 3 )$$

Another technique is Cholesky inverse square root decomposition, as is given in (4):

$$\{ \begin{matrix}{R}_{e , l}^{- 1 / 2} = {L}^{- 1} \\ where , \\ L is a lower triangular matrix satisfyingthe followingproperty \\ {LL}^{H} = {R}_{e , l}\end{matrix} \} \qquad ( 4 )$$

Other inverse square root decompositions are also possible, such as Newton based inverse square root decomposition.

The whitened transformations \tilde{y}ₗ, and \tilde{h}ₗ, for each path l are then matched filtered, for example using the matched filtering unit 104 of the rake receiver 102, to obtain a filtered signal for a given path l: \tilde{x}ₗ=\tilde{h}ₗ^{H}\tilde{y}ₗ. The one or more filtered signals are then combined as given in (5), for example using the combiner unit 106 of the rake receiver 102, to provide a combined whitened signal for all paths of the receive antennas Nᵣₓ.

$$\{ \begin{matrix}{x}_{NW} = {\sum }_{i = 1}^{{N}_{l}} {\tilde{x}}_{l} \\ where , \\ {N}_{l} is the number of paths or fingers\end{matrix} \} \qquad ( 5 )$$

### Representative Processes

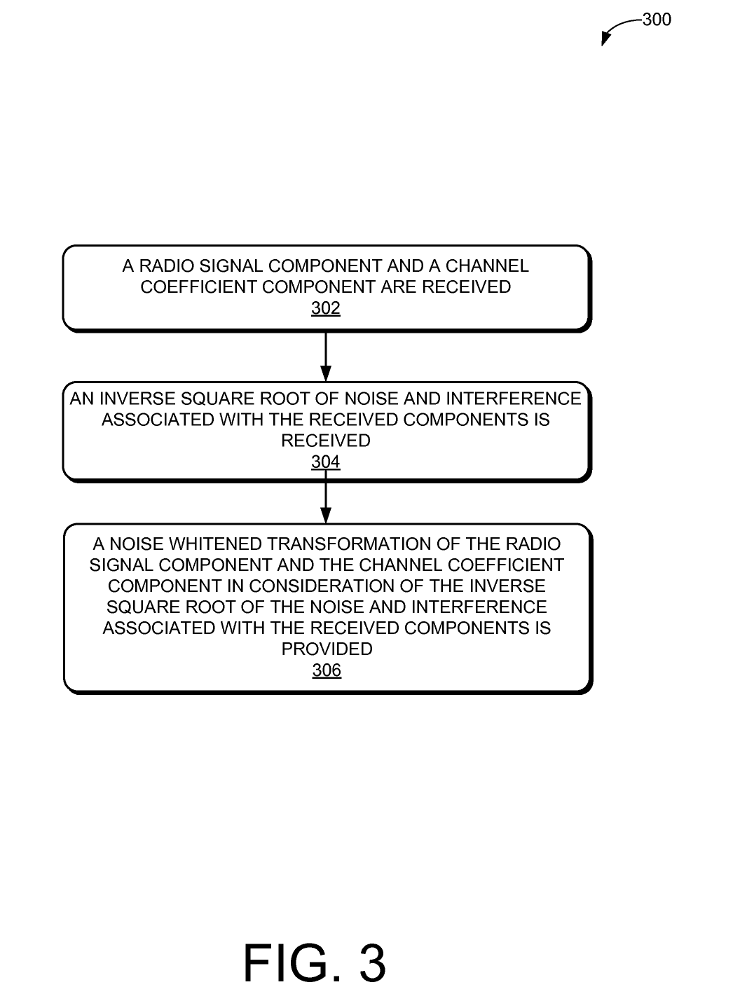

FIG. 3 illustrates a representative noise whitening process 300 for enabling interference and noise mitigation. The illustrated process 300 may be performed by the one more of the implementations described herein, such as those illustrated in FIGS. 1 and 2.

At Act 302, a processor, such as a communication processor associated with a receiver that is also a computing device, is enabled to execute computer instructions that enable receiving a radio signal component and a channel coefficient component. The radio signal component and the channel coefficient component may be provided by one or more antennas.

At Act 304, the processor may execute computer instructions that enable receiving an inverse square root of noise and interference associated with the received components. The inverse square root of the noise and interference may be provided by an inverse square root calculation unit.

At Act 306, the processor may execute computer instructions that enable providing a noise whitened transformation of the radio signal component and the channel coefficient component in consideration of the inverse square root of the noise and interference associated with the received components.

### Illustrative Apparatus

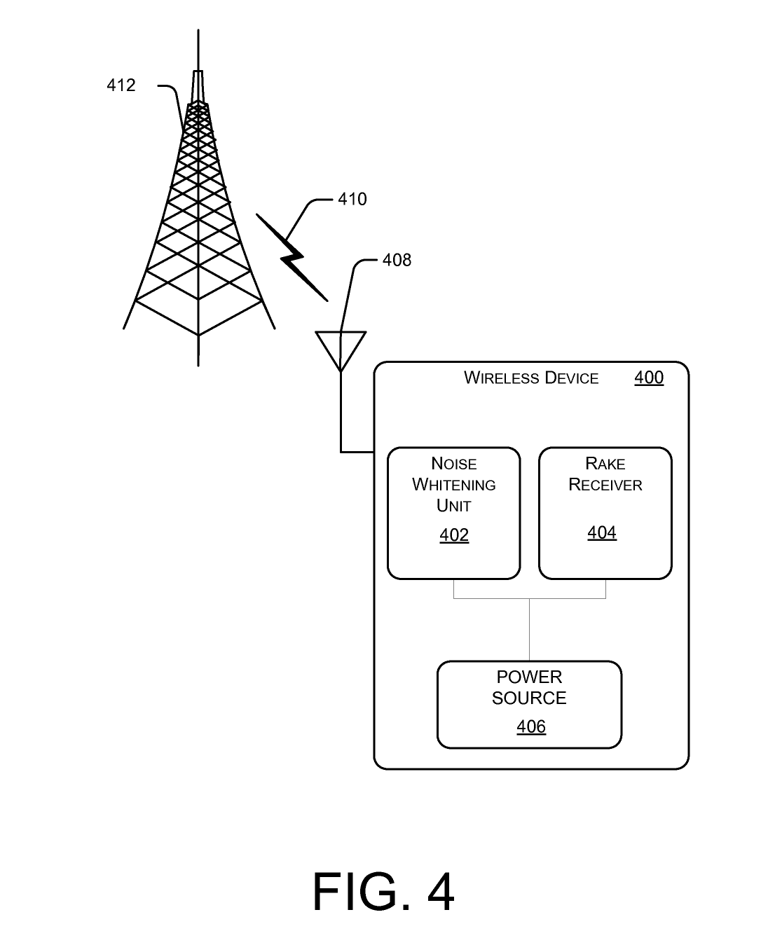

FIG. 4 a representative wireless device 400 (i.e., an apparatus) that may incorporate an exemplary receiver that implements noise whitening. For purposes of non-limiting example, the wireless device 400 is presumed to include various resources that are not specifically depicted in the interest of clarity. The wireless device 400 is further presumed to be configured to perform in one or more wireless operating modes (e.g., cellular communications, global positioning system (GPS), UMTS and LTE receptions, etc.).

The wireless device 400 includes may include a noise whitening unit 402 and a rake receiver 404. The noise whitening unit 402 and the rake receiver 404 may function in a manner as described herein. That is, the noise whitening unit 402 may be implemented by way of the noise whitening unit 101 and the rake receiver 404 may be implemented by way of the rake receiver 102. Other implementations in accordance with the present teachings may also be used.

The wireless device 800 further includes a source of electrical energy or “power source” 406. In one or more implementations, the power source 406 is defined by one or more batteries. In other implementations, the power source 406 may be defined by an inductively coupled power supply that is energized by an electromagnetic illumination field provided by some entity external to the wireless device 400. Other types of power source 406 may also be used. In any case, the power source 406 is coupled so as to provide electrical energy to the noise whitening unit 402 and the rake receiver 404. In this way, the wireless device 400 is presumed to be operable in a portable manner.

The wireless device 400 further includes an antenna 408, or a plurality of antennas. The wireless device 400 is presumed to operate by way of wireless signals 410, including receiving signals that are processed at least by the noise whitening unit 402 and the rake receiver 404. A single cellular tower 412 is depicted in the interest of simplicity. However, it is to be understood that other resources (not shown) of a corresponding wireless network are also present and operative as needed so as to enable the wireless device 400 to perform its various functions (cellular communications, Internet access, etc.). The wireless device 400 is a general and non-limiting example of countless devices and systems that may be configured and operating in accordance with the device arrangements and techniques of the present teachings.

The foregoing systems, arrangements, units, systems, methods and techniques achieve interference and/or noise mitigation using noise whitening techniques that may be readily implemented in a receiver, such as a rake receiver.

The systems, arrangements, units, systems, methods and techniques of the described implementations may be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a transmitter/receiver, any comparable device, or the like. In general, any apparatus capable of implementing a state machine that is in turn capable of implementing the methodology described and illustrated herein may be used to implement the various communication methods, protocols and techniques according to the implementations.

Furthermore, the disclosed procedures may be readily implemented in software using object or object-oriented software development environments that provide portable source code that can be used on a variety of computer or workstation platforms. Alternatively, the disclosed arrangements may be implemented partially or fully in hardware using standard logic circuits or VLSI design. The communication arrangements, procedures and protocols described and illustrated herein may be readily implemented in hardware and/or software using any known or later developed systems or structures, devices and/or software by those of ordinary skill in the applicable art from the functional description provided herein and with a general basic knowledge of the computer and telecommunications arts.

### CONCLUSION

Although the implementations of the disclosure have been described in language specific to structural features and/or methodological acts, it is to be understood that the implementations are not necessarily limited to the specific features or acts described. Rather, the specific features and acts are disclosed as representative forms of implementing the invention.

What is claimed is:

1. A receiver, comprising:
a plurality of antennas each configured to receive radio signals from a plurality of transmission paths;
a plurality of sets of rake fingers, each set of rake fingers coupled to a respective one of the plurality of antennas; and
a noise whitening unit disposed between the plurality of antennas and the plurality of sets of rake fingers, the noise whitening unit to mitigate interference and noise associated with the received radio signals.

2. The receiver according to claim 1, wherein the noise whitening unit comprises a plurality of noise whitening units, each one of the plurality of noise whitening units coupled an individual one of the plurality of sets of rake fingers.

3. The receiver according to claim 2, further comprising an inverse square root computation unit coupled to an input of each of the plurality of noise whitening units, the inverse square root computation unit to receive noise and interference associated with the received radio signals and provide an inverse square root of the noise and interference associated with the received radio signals.

4. The receiver according to claim 1, further comprising an inverse square root computation unit coupled to an input of the noise whitening unit, the inverse square root computation unit to receive noise and interference associated with the received radio signals and provide to the input of the noise whitening unit an inverse square root of the noise and interference associated with the received radio signals.

5. The receiver according to claim 1, wherein the noise whitening unit is to receive a first signal path from a first antenna of the plurality of antennas and a second signal path from a second antenna of the plurality of antennas, the first signal path including at least a radio signal component and a channel coefficients component and the second signal path including at least a radio signal component and a channel coefficients component.

6. The receiver according to claim 5, wherein the noise whitening unit is to output a whitened transformation of the radio signal component and a whitened transformation of the channel coefficients component associated with the first signal path, and is further to output a whitened transformation of the radio signal component and a whitened transformation of the channel coefficients component associated with the first signal path.

7. The receiver according to claim 6, wherein providing each of the whitened transformations includes considering a covariance of the interference and noise associated with the received radio signals.

8. The receiver according to claim 1, further comprising a matched filtering unit coupled to at least one of the plurality of sets of rake fingers, the matched filtering unit to receive signals from at least one of the plurality of sets of rake fingers and provide one or more signals matched to a pulse shape of the desired signal in an output signal of the noise whitening unit.

9. The receiver according to claim 8, further comprising a combiner unit coupled to the matched filtering unit, the combiner unit to combine a plurality of signals output from the matched filtering unit.

10. A non-transitory computer readable medium storing a computer readable instructions executable by at least one processor to cause a computer to execute a noise whitening method, the method comprising:
receiving at least a radio signal component and a channel coefficient component;
receiving an inverse square root of noise and interference associated with the received components;
providing a noise whitened transformation of the radio signal component and the channel coefficient component in consideration of the inverse square root of the noise and interference associated with the received components.

11. The noise whitening method according to claim 10, wherein the receiving includes receiving a radio signal component and a channel coefficient component for a first signal path and receiving a radio signal component and a channel coefficient component for a second signal path.

12. The noise whitening method according to claim 11, wherein the first signal path is associated with a first antenna and the second signal path is associated with a second antenna.

13. The noise whitening method according to claim 10, further comprising performing an Eigen value decomposition of the radio signal component and the channel coefficient component to obtain the inverse square root of the noise and interference associated with the received components.

14. The noise whitening method according to claim 10, further comprising performing a Cholesky inverse square root decomposition of the radio signal component and the channel coefficient component to obtain the inverse square root of the noise and interference associated with the received components.

15. An apparatus, comprising:
a noise whitening unit at least partially embodied as hardware, the noise whitening unit to:
receive at least a radio signal component and a channel coefficient component;
receive an inverse square root of noise and interference associated with the received components; and
provide a noise whitened transformation of the radio signal component and the channel coefficient component in consideration of the inverse square root of the noise and interference associated with the received components.

16. The apparatus according to claim 15, further comprising a receiver coupled to the noise whitening unit, the receiver to receive the noise whitened transformation of the radio signal component and the channel coefficient component.

17. The apparatus according to claim 16, further comprising a first antenna and a second antenna, the first antenna to provide a first radio signal component and a first channel coefficient component to the noise whitening unit and the second antenna to provide a second radio signal component and a second channel coefficient component to the noise whitening unit, wherein the whitening unit is to provide noise whitened transformations of the first and second radio signal components and the first and second channel coefficient components in consideration of the inverse square root of the noise and interference associated with the received first and second components.

18. The apparatus according to claim 16, wherein the receiver is a rake receiver comprising a plurality of rake fingers, a matched filtering unit and a combiner unit.

19. The apparatus according to claim 15, wherein the noise whitening unit is to further perform an Eigen value decomposition of the radio signal component and the channel coefficient component to obtain the inverse square root of the noise and interference associated with the received components.

20. The apparatus according to claim 15, wherein the noise whitening unit is to further perform a Cholesky inverse square root decomposition of the radio signal component and the channel coefficient component to obtain the inverse square root of the noise and interference associated with the received components.
